(19) United States
(12) Patent Application Publication
(10) Pub. No.: US 2026/0214021 A1
(43) Pub. Date: Jul. 23, 2026

(54) METHOD AND APPARATUS FOR SUPPORTING HYBRID FEDERATED LEARNING WORKLOAD IN COMMUNICATION SYSTEM

(71) Applicant: Samsung Electronics Co., Ltd., Suwon-si, Gyeonggi-do (KR)

(72) Inventors: Chadi KHIRALLAH, Chertsey (GB); David Gutierrez ESTEVEZ, Chertsey (GB); Joan Pujol ROIG, Chertsey (GB)

(21) Appl. No.: 19/139,103

(22) PCT Filed: Dec. 6, 2023
(86) PCT No.: PCT/KR2023/020018

§ 371 Date: Jun. 13, 2025

(30) Foreign Application Priority Data
Dec. 13, 2022 (GB) 2218775.1
Nov. 10, 2023 (GB) 2317270.3

(51) Int. Cl. H04L 41/16; G06N 3/098

(52) U.S. Cl. CPC H04L 41/16; G06N 3/098

(57) ABSTRACT

The present disclosure relates to a method for Federated Learning (FL) in a communication system such as a 5G network and an apparatus therefor. Specifically, the present disclosure provides a method for effectively combining one or more models using horizontal federated learning (HFL) and/or one or more models using vertical federated learning (VFL) and an apparatus therefor.

### TECHNICAL FIELD

The present disclosure relates to a communication system. Particularly, the present disclosure relates to Federated Learning (FL) in a communication system such as a 5G network.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyperconnectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Solution to Problem

Provided herein are a method of federated learning (FL) model aggregation in a communication system, the method comprising: combining one or more models using horizontal FL (HFL) and/or one or more models using vertical FL (VFL), and a network entity including a federated learning aggregator manager (FLAM) configured to implement the method.

Preferably, the FLAM may be a part of or co-located with an existing or newly defined network entity; and/or one or more steps performed by the FLAM are performed by a set of one or more network entities including an existing network entity and/or a newly defined network entity.

Provided herein is a method of creating a federated learning (FL) workload by an application function (AF) in a communication system, the method comprising: sending, to a federated learning aggregator manager (FLAM), a message comprising information related to the FL workload, wherein the message causes the FLAM to select a list of possible candidates from a pool of available parties including UEs for the FL workload and to request, to a session management function (SMF), inclusion of the pool of available parties to the FL workflow; starting a timer; and receiving, from the FLAM, the list of possible candidates.

Additionally or alternatively, the information may comprise one or more of: requested Quality-of-Service profile; at least one training ending condition; maximum/minimum number of requested participants; minimum/maximum amount of resources; a list of desired data features and labels; or assistance information related to FL workload creation and/or handling.

Additionally or alternatively, the method may further comprise, in case that the FLAM does not have access to enough parties and/or resources across the pool of available parties to accommodate the FL workload, or data features do not match features requested by the AF, expiring the timer and starting a FL with another FLAM entity.

Provided herein is a method of subscribing to a federated learning (FL) workload by a party including at least one of a user equipment (UE) or a model training logical function (MTLF), the method comprising: submitting a subscription request to a session management function (SMF); forwarding, to a federated learning aggregator manager (FLAM), the subscription request, wherein the subscription request causes the FLAM to add the party to a pool of available parties for the FL workload; and starting a timer.

Additionally or alternatively, the subscription request may comprise one or more of: available amount of hardware resources; a set of data features and labels available within its dataset, and a sample space ID; or a number of active FL workloads that the party is currently involved.

Additionally or alternatively, starting the timer may be in response to receiving an acknowledge message from the SMF, wherein the acknowledge message may confirm that the party is included to the pool of available parties for FL workloads.

Additionally or alternatively, in case that the timer expires without receiving any further instruction, the party may become available to other workloads.

Additionally or alternatively, the method may further comprise: communicating periodically status to the FLAM, wherein the status may comprise one or more of: a number of active FL workloads the party is taking part in; available computational, memory and storage resources; protocol data unit (PDU) error rate; or available Features list, labels and sample space ID.

Additionally or alternatively, a training mechanism may be reconfigured by the FLAM.

Provided herein is a method of training a machine learning (ML) model of a federated learning (FL) workload by an application function (AF) in a communication system, the method comprising: sending, to a federated learning aggregator manager (FLAM), a request for the FL workload, wherein the request causes the FLAM to select a pool of available parties for the FL workload; receiving, from the FLAM, at least one suggested model aggregation configuration; implementing a specific model aggregation configuration of the at least one suggested model aggregation configuration; sharing, with at least one party of the pool of available parties, a model based on the specific model aggregation configuration; receiving, from the at least one party of the pool of available parties, at least one model trained using local datasets; aggregating the received at least one model using horizontal model aggregation; and transmitting the aggregated model.

Provided herein is a method of training a machine learning (ML) model of a federated learning (FL) workload by a federated learning aggregator manager (FLAM) in a communication system, the method comprising: identifying one or more common identifiers served by a pool of available parties; aligning data of local datasets of the pool of available parties; receiving, from at least one party of the pool of available parties, an output of a forward propagation process executed using a local dataset and/or a local model; computing a top model using the received output of the forward propagation process; and forwarding, to the at least one party of the pool of available parties, information from the top model, wherein the information from the top model causes the at least one party to update the local model.

Additionally or alternatively, parties having one or more common identifiers may be grouped into at least one group, and the forward propagation process may be executed using a same model for each group.

### BRIEF DESCRIPTION OF DRAWINGS

For a better understanding of the disclosure, and to show how exemplary embodiments of the same may be brought into effect, reference will be made, by way of example only, to the accompanying diagrammatic Figures, in which:

FIG. 1 schematically depicts a classical FL approach;

FIG. 2 is an illustration of horizontal FL (HFL);

FIG. 3 is an illustration of vertical FL (VFL);

FIG. 4 is a flow chart of a method according to an exemplary embodiment;

FIG. 5 is a flow chart of a method according to an exemplary embodiment;

FIG. 6 schematically depicts an example of a VFL procedure;

FIG. 7 schematically depicts a RAN slicing use case; and

FIG. 8 schematically depicts a schematic diagram of a network entity in accordance with an example of the present disclosure.

### MODE FOR THE INVENTION

Wireless or mobile (cellular) communications networks in which a user equipment (UE) communicates via a radio link with a network of base stations, or other wireless access points or nodes, have undergone rapid development through a number of generations. The 3^{rd} Generation Partnership Project (3GPP) design, specify and standardise technologies for mobile wireless communication networks. Fourth Generation (4G) and Fifth Generation (5G) systems are now widely deployed. In this disclosure, a User Equipment (UE) may be interchangeably referred to as a terminal, a device, a mobile terminal, a mobile device, a mobile handset, and so on. In this specification, a base station may be interchangeably referred to as a gNB (or gNodeB), an eNB (or eNodeB), a node, an access point, an access node, a Transmission/Reception Point (TRP), a Radio Access Network (RAN), a network device (or network apparatus), and so on.

GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the E-UTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies. New frameworks and architectures are also being developed as part of 5G networks in order to increase the range of functionality and use cases available through 5G networks. One such new framework is the use of Artificial Intelligence/Machine Learning (AI/ML) for the optimisation of the operation of 5G networks.

Typically, AI/ML algorithms rely on large datasets accessible via data centers or shared databases to train models. However, in many real-world applications, the data belongs to the clients, and the clients' datasets are often sensitive to privacy concerns. Thus, building high-quality models is often challenging as data-hungry machine learning solutions rely on having access to large volume of (clients') data. To overcome this limitation, Federated Learning (FL) was proposed in “Yang, Q., Liu, Y., Cheng, Y., Kang, Y., Chen, T. and Yu, H., 2019. Federated learning. Synthesis Lectures on Artificial Intelligence and Machine Learning, 13(3), pp. 1-207.”, which is incorporated herein by reference in its entirety.

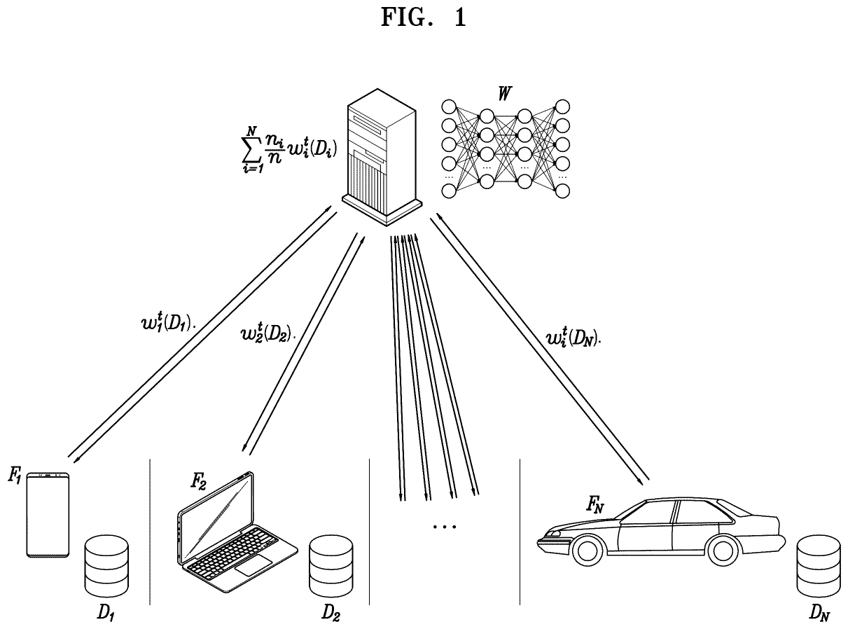

FIG. 1 schematically depicts a classical Federated Learning (FL) approach.

FL is a privacy-enhancing technique that allows multiple parties to collaboratively train a model without completely sharing data. Consider that there are N participants

$${\{ {ℱ}_{i} \}}_{i = 1}^{N}$$

interested in establishing and training a cooperative ML model [symbol] . Each party has their respective datasets [symbol] . Traditional ML approaches consist of collecting all data

$${\{ {𝒟}_{i} \}}_{i = 1}^{N}$$

together to form a centralized dataset [symbol] at one data server, and the expected model [symbol] is trained by using the dataset [symbol] . On the other hand, FL is a reform of ML process in which the participants [symbol] with data [symbol] jointly train a target model [symbol] without aggregating their data. Respective data [symbol] is only stored on the owner [symbol] and not exposed to others.

A canonical federated averaging algorithm (FedAvg) based on gradient-descent techniques is presented in FIG. 1, which is widely used in FL systems. The canonical federated averaging algorithm is proposed in “H. B. McMahan, E. Moore, D. Ramage, and B. A. y Arcas, Communication-efficient learning of deep networks from decentralized data, CoRR, vol. abs/1602.05629, 2016. [Online]. Available: http:/arxiv.org/abs/1602.05629” which is incorporated herein by reference in its entirety. It establishes a server-client architecture, where the server, known as parameter server, is the coordinator and has the initial ML [symbol] ^{o} model and is responsible for aggregation. This model is distributed to FL workflow participants which know the optimizer settings and loss function (accuracy, recall, and F1-score, etc). At time t, each participant i uses its local data [symbol] to perform one step (or multiple steps) of gradient descent on the current model parameter

$${𝒲}_{i}^{t} ( {𝒟}_{i} ) .$$

After receiving the local parameters from participants, the central coordinator updates the global model using a weighted average,

$${𝒲}^{t + 1} = {\sum }_{i = 1}^{N} \frac{{n}_{i}}{n} {𝒲}_{i}^{t} ( {𝒟}_{i} )$$

where nᵢ indicates the number of training data samples that the i-th participant has and n denotes the total number of samples contained in all the datasets. Finally, the coordinator sends the aggregated model weights [symbol] ^{t+1} back to the participants. The aggregation process is performed until a predefined stopping criteria is met.

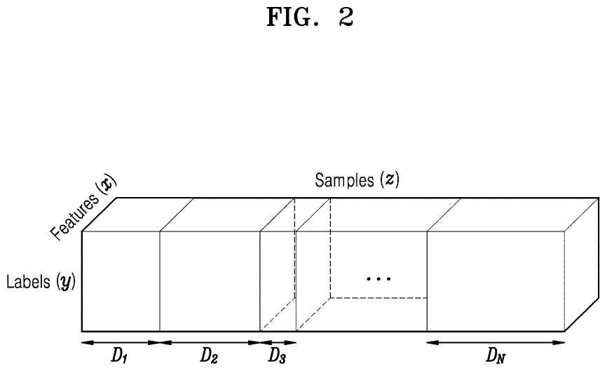

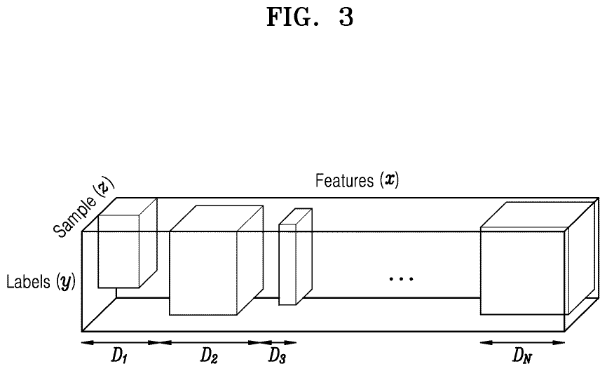

Based on the way data is partitioned within a feature and sample space, FL may be classified as Horizontal Federated Learning (HFL) or Vertical Federated Learning (VFL), which is proposed in “Q. Yang, Y. Liu, T. Chen, and Y. Tong, Federated machine learning: Concept and applications, ACM Transactions on Intelligent Systems and Technology (TIST), vol. 10, no. 2, pp. 1-19, 2019.” that is incorporated herein by reference in its entirety. In FIG. 2 and FIG. 3, these categories are depicted, respectively.

### Horizontal Federated Learning (HFL)

To clarify the difference we assume that each dataset includes three types of data categories, i.e., the feature space [symbol] ᵢ, the label space [symbol] ᵢ, and the sample space or environment [symbol] ᵢ, as shown in FIG. 2.

HFL refers to the case in which participants have their datasets with a small sample overlap, while most of the data features are aligned. That is, for any two participants i,j, the feature space [symbol] and label space [symbol] is assumed to be the same, [symbol] ᵢ= [symbol] ⱼ, [symbol] ᵢ= [symbol] ⱼ∀i≠j, but the sampling ID space [symbol] ᵢ is assumed to be different ( [symbol] ᵢ≠ [symbol] ⱼ). The objective of HFL is to increase the amount of data with similar features, while keeping the original data from being transmitted, thus improving the performance of the training model.

For example, a use case on HFL, would be the case of distinct instantiations of the same slice orchestration ML engine, deployed into the same type of network slice across different network sides. For the same type of service, the data from the different connected devices is strongly correlated because the data flows not only have similar features (e.g., the service type mark), but also compete for the radio and computing resources in similar slices.

FIG. 1 is an illustration of horizontal FL (HFL).

### Vertical Federated Learning (VFL)

On the other hand, VFL refers to the case where different participants with various targets usually have datasets that have different feature spaces, but those participants may serve a large number of common users. Formally, this means that for any two participants i,j, the feature space [symbol] and label space [symbol] are assumed to be the different, [symbol] ᵢ≠ [symbol] ⱼ, [symbol] ᵢ≠ [symbol] ⱼ∀i≠j, but the sampling ID space [symbol] ᵢ is assumed to be the same ( [symbol] ᵢ≠ [symbol] ⱼ). The heterogeneous feature spaces of distributed datasets can be used to build more general and accurate models without releasing private data. FIG. 3 shows an example of VFL scenario.

FIG. 3 is an illustration of vertical FL (VFL).

For example, VFL can be used for distinct slice orchestration AI engines, deployed on separate slide types (e.g. eMBB, URLLC) that share the same pool of resources, i.e., slices that co-exist together. An initial step in VFL is to align samples, i.e., determine which samples are common to the participants. It is the objective of VFL to collaborate in building a shared ML model by exploiting all features collected by each participant, where the fusion and analysis of existing features can even infer new features.

In HFL each participant maintains a local model, identical to the global model and to the model of the other participants of the federation, and receives periodical model updates from the parameter server. Thus, each individual model can be used for inference. However, in VFL each participant possesses a part of the full model. As a result, messages exchanged among participants in VFL are the intermediate outputs (learning representations) of the local data based on bottom models and their gradients, in contrast to the local model parameters or updates in HFL.

### Hybrid Federated Learning (HyFL)

Finally, the hybrid FL solution represents a combination of the two aforementioned solutions. As an initial step of this method, HFL aggregation is performed. This is followed by a VFL aggregation of the resulting models. The goal of the VFL part is to identify the Private Set Intersection (PSI) of the resulting HFL models and aggregate these different features in order to compute the training loss and gradients in a privacy-preserving manner to build a model with data from all parties collaboratively.

### FL Status in 3GPP

The current study in the 3rd Generation Partnership Project (3GPP) has not addressed all the possible aggregation models for Federated Learning. Current focus is on HFL where there is an Application Function (AF) communicating with the 5GC using a Network Exposure Function (NEF) to set up connections with UEs associated to a particular Quality of Service (QoS) treatment, so that FL models (or training data) can be sent to the UEs. Once the UEs are selected for FL workflow, a HFL training phase is followed (either synchronous or asynchronous) with a predefined aggregation mechanism (FedAvg).

### SUMMARY OF THE PRESENT DISCLOSURE

Nevertheless, there are other possible FL model combining techniques which do not fit under current HFL methodology, or there are different HFL combining solutions that are not considered. Such engagement models have not been addressed by 3GPP, limiting the performance of models and the access to data of such models. To overcome this limitation, the present disclosure identifies different methods for model aggregation and proposes a novel network function to manage the workflow. This function collects information about the model, recognizes its type, KPIs, features, and combines them horizontally, vertically, or in a hybrid fashion, whenever possible. Innovative aggregation solutions may lead to faster training process and more generic ML models that are less susceptible to suboptimal convergence.

Hence, generally, the present disclosure provides a novel Hybrid Federated Learning (FL) method for combining models, where the FL models can be aggregated vertically, horizontally or a combination between horizontal and vertical. Furthermore, the present disclosure provides creation of a new network function (NF) or network entity, called FLAM (Federated Learning Aggregator Manager), to assist and configure the FL model aggregation workflows.

In more detail, the present disclosure provides:
A novel methodology for Hybrid Federated Learning (FL) model aggregation, where the FL models can be combined:
   Horizontally (HFL): allow multiple parties that own the same attributes (e.g. features and labels) of distinct data entities to jointly train a model.
   Vertically (VFL): allow multiple parties that own different attributes (e.g. features and labels) of the same data entity or entities to jointly train a model.
   Hybrid (HyFL): Combines the aforementioned model aggregation solutions to jointly train a model. It combines multiple (or single) parties that own the same attributes of distinct data entities (HFL), with multiple (or single) parties that own different attributes of the same data entity (VFL).
Definition of a novel entity, co-located with a new or existing (logical) NF (or network entity) that we refer to as FL Aggregator Manager (FLAM). The FLAM will:
   Assist on the creation/run to completion/destruction of an FL workload;
   Oversee the subscription process of a pool of UE(s) or networks nodes (entities, or functions) wishing to take part in an FL workload with any of the above mentioned model aggregation strategies;
   Cluster the UEs based on the selected model aggregation mode;
   Establish the KPIs for the distinct model aggregation types;
   Decide or propose the model aggregation policy to be adopted.
   Any other process related to the model aggregation.
Definition of a new set of monitoring KPIs that will be leveraged to perform the VFL aggregation mechanism:
   Private Set Intersection (PSI): which identifies the intersection of training samples from all UEs by using sample IDs to align data instances.
   Shapley values: which represents the average marginal contribution of a specific feature across all possible feature combinations.
   Cosine similarity: Which computes a numerical metric for similarity between sample features.
   Others KPIs related to VFL model aggregation mechanism.

A first aspect of the present disclosure provides a method of Federated Learning (FL) model aggregation in a communication system such as a 5G network, the method comprising: combining one or more models using horizontal FL (HFL) and/or one or more models using vertical FL (VFL).

Additionally and/or alternatively, the first aspect provides a method of Federated Learning (FL) aggregation in a communication system such as a 5G network, the method comprising: combining one or more models using horizontal FL (HFL) and/or one or more models using vertical FL (VFL).

Additionally and/or alternatively, the first aspect provides a method of Federated Learning (FL) model aggregation in a communication system such as a 5G network, the method comprising: combining one or more horizontal FL (HFL) models and/or one or more vertical FL (VFL) models.

A second aspect of the present disclosure provides a network entity, for example a Federated Learning Aggregator Manager (FLAM) configured to implement the method according to the first aspect.

The aspect may include any step or feature with respect to the first aspect.

In an example, the FLAM may be a part of (or co-located with) an existing (or newly defined) network entity(-ies) (and/or function(s)); and/or one or more steps performed by the FLAM may be performed by a set of (one or more) network entity(-ies) and/or function(s), for example by an existing network entity (or function) and/or a newly defined network entity (or function).

A third aspect of the present disclosure provides a method of creating a Federated Learning workload in a communication system such as a 5G network comprising an Application Function (AF), a Federated Learning Aggregator Manager (FLAM) and a Session Management Function (SMF), the method comprising: sending, by the AF to the FLAM, a message comprising information related to the FL workload; starting, by the AF, a timer; selecting, by the FLAM, a list of possible candidates from a pool of available parties, such as User Equipments (UEs), for the FL workload, responsive to receiving the message; requesting, by the FLAM to the SMF, inclusion of the pool of available parties to the FL workflow; and sending, by the FLAM to the AF, the list of possible candidates.

The third aspect may include any step or feature with respect to the first aspect and/or the second aspect.

In an example, the information may comprise one or more of: requested Quality-of-Service profile; training ending condition(s), maximum/minimum number of requested participants; minimum/maximum amount of resources; list of desired data features and labels; and any other assistance information related to FL workload creation and/or handling.

In an example, if the FLAM does not have access to enough parties and/or resources across the pool of UEs to accommodate the new FL workload, or the data features do not match the requested by the AF, the method may comprise expiring the AF timer and starting, by the AF, a FL with another FLAM entity.

In an example, the FLAM may be a part of (or co-located with) an existing (or newly defined) network entity(-ies) (and/or function(s)); and/or one or more steps performed by the FLAM may be performed by a set of (one or more) network entity(-ies) and/or function(s), for example by an existing network entity (or function) and/or a newly defined network entity (or function).

A fourth aspect of the present disclosure provides a method of subscribing, by parties in a communication system such as a 5G network comprising a FLAM and a SMF, to a Federated Learning (FL) workload, comprising: submitting, by a party to the SMF, a subscription request; forwarding, by the SMF to the FLAM, the subscription request; adding, by the FLAM, the party to a pool of available parties, such as UEs, for the FL workload; and starting, by the party, a timer.

The fourth aspect may include any step or feature with respect to the first aspect, the second aspect and/or the third aspect.

In an example, the subscription request may comprise one or more of: available amount of hardware resources; set of data features and labels available within its dataset, and the sample space ID; and the number of active FL workloads that the party is currently involved.

In an example, starting, by the party, the timer may be in response to receiving, by the party, an acknowledge message from the SMF, wherein the acknowledge message may confirm the party's inclusion to the available participants for FL workloads.

In an example, if the timer expires without receiving any further instruction, the party may become available to other workloads.

In an example, the method may comprise communicating, for example periodically, by the party, its status to the FLAM, for example wherein the status may comprise one or more of: number of active FL workloads the party is taking part in; available computational, memory and storage resources; Protocol Data Unit (PDU) error rate; and available Features list, labels and sample space ID.

In an example, the method may comprise reconfiguring, by the FLAM, a training mechanism.

In an example, the FLAM may be a part of (or co-located with) an existing (or newly defined) network entity(-ies) (and/or function(s)); and/or one or more steps performed by the FLAM may be performed by a set of (one or more) network entity(-ies) and/or function(s), for example by an existing network entity (or function) and/or a newly defined network entity (or function).

A fifth aspect of the present disclosure provides a method of training a machine learning (ML) model of a FL workload in a communication system such as a 5G network comprising a AF, a FLAM and a pool of available parties, such as UEs, the method comprising: sending, by the AF to the FLAM, a request for the FL workload; selecting, by the FLAM, the pool of available parties for the FL workload; sharing, by the FLAM to the AF, the suggested model aggregation(s) configuration(s); implementing, by the AF, a specific model aggregation mode (e.g. configuration); sharing, by the AF with the pool of available parties, a model (e.g. based on the specific model aggregation mode); training, by the respective parties of the pool of available parties, respective models (e.g. instances of the model), respectively using local datasets; sending, by the respective parties of the pool of available parties to the AF, the updated (e.g. trained) respective models; aggregating, by the AF, the received updated respective models using horizontal model aggregation; transmitting, for example broadcasting or sending, the aggregated model; and receiving, by the FLAM, the aggregated model.

The fifth aspect may include any step or feature with respect to the first aspect, the second aspect, the third aspect and/or the fourth aspect.

In an example, the FLAM may be a part of (or co-located with) an existing (or newly defined) network entity(-ies) (and/or function(s)); and/or one or more steps performed by the FLAM may be performed by a set of (one or more) network entity(-ies) and/or function(s), for example by an existing network entity (or function) and/or a newly defined network entity (or function).

A sixth aspect of the present disclosure provides a method of training a machine learning (ML) model of a FL workload in a communication system such as a 5G network comprising a AF, a FLAM and a pool of available parties, such as UEs, the method comprising: identifying, by the FLAM, one or more common identifiers served by the pool of available parties; aligning, by the FLAM, data of the respective local datasets of the pool of available parties; executing, by the respective parties of the pool of available parties, forward propagation processes using, for example, respective local datasets and/or local models; transmitting, by the respective parties of the pool of available parties to the FLAM, respective outputs of the forward propagation processes; computing a top model using the respective outputs of the forward propagation processes; forwarding, by the FLAM to the respective parties of the pool of available parties, information from the top model; updating, by the respective parties of the pool of available parties, respective local models using the information from the top model.

The sixth aspect may include any step or feature with respect to the first aspect, the second aspect, the third aspect, the fourth aspect and/or the fifth aspect.

In an example, the FLAM may be a part of (or co-located with) an existing (or newly defined) network entity(-ies) (and/or function(s)); and/or one or more steps performed by the FLAM may be performed by a set of (one or more) network entity(-ies) and/or function(s), for example by an existing network entity (or function) and/or a newly defined network entity (or function).

A seventh aspect of the present disclosure provides a method of training a machine learning (ML) model of a FL workload in a communication system such as a 5G network comprising a AF, a FLAM and a pool of available parties, such as UEs, the method comprising: identifying, by the FLAM, one or more common identifiers served by the pool of available parties; grouping, by the FLAM, parties having one or more common identifiers into groups; aligning, by the FLAM, data of the respective local datasets of the parties of the grouped parties; executing, by the respective parties of the pool of available parties, forward propagation processes using, for example, respective local datasets and/or the same model for each group; transmitting, by the respective parties of the pool of available parties to the FLAM, respective outputs of the forward propagation processes; computing a top model using the respective outputs of the forward propagation processes; forwarding, by the FLAM to the respective parties of the pool of available parties, information from the top model; updating, by the respective parties of the pool of available parties, respective local models using the information from the top model.

The seventh aspect may include any step or feature with respect to the first aspect, the second aspect, the third aspect, the fourth aspect, the fifth aspect and/or the sixth aspect.

In an example, the FLAM may be a part of (or co-located with) an existing (or newly defined) network entity(-ies) (and/or function(s)); and/or one or more steps performed by the FLAM may be performed by a set of (one or more) network entity(-ies) and/or function(s), for example by an existing network entity (or function) and/or a newly defined network entity (or function).

### Problem the Present Disclosure is Solving

The current state-of-the-art in 3GPP for FL model aggregation only focus on horizontal model aggregation, i.e., a common model is distributed among all participants of the FL workflow. However there exist other model combating solutions that have no fit under current methodology. The present disclosure proposes a novel methodology for Hybrid Federated Learning (HyFL) model aggregation, where the FL models can be aggregated in multiple modes, i.e., horizontal, vertical or Hybrid.

The present disclosure provides use of novel entity, co-located with a new or existing (logical) NF, named FLAM, which is in charge of assisting on the creation/run to completion/destruction of an FL workload, recognizing/suggesting the best aggregation mechanism, and selecting the participants (e.g., UEs, MEC servers, etc.) for any FL workload. The present disclosure also makes provisions for the participants taking part in the FL workload to be re-organized during the execution of the FL workload.

The present disclosure also provides a new set of monitoring metrics that may be leveraged to perform the VFL and HyFL aggregation mechanism. Such set may include the definition of Private Set Intersection, Shapley values, Cosine similarity, among other metrics.

The FL operation of an AI/ML-based application over 5G System (5GS) encounters and suffers from rigidity constraints when it is expected that all parties involved in a FL workflow share the same model or that no mixed combination of models is considered to power a more general learning framework that results in a global model (referred hereafter as the top model). The present disclosure provides a more flexible FL operation by leveraging the following functional enablers:
1. Enabling a server application or a group of server applications to engage in FL operations via HFL, VFL and/or HyFL. In these operations, the application(s) server(s) work together to identify appropriate features and/or labels for the model. If VFL is selected the private set intersections (PSI) protocol is triggered. PSI is a secure multiparty protocol which allows multiple participants to find common IDs available across their data.
2. Enabling the participants (UE, edge servers, network entity/function, etc.) to request joining a new and/or an already existing FL group/session, which may be used as part of FL workflow, where the participants may provide their model updates if/when they decide to do so and/or the network authorizes it.
3. Listing a set of KPIs for each model aggregating solution, which will be suggested to the AF(s) so that they can keep track of it.

ML models need this flexibility in order to take advantage of all available data sources distributed across devices or data owners. Where all participants possess the same attribute space but a different sample space, HFL will be leveraged. On the other hand, VFL can promote collaborations among non-competing applications/entities with vertically partitioned data, i.e., data that has some overlap in the attribute space and belongs to the same sample space. To this end, the 5GS should be enabled to support these different aggregation modes.

Additionally, the 3GPP Technical Report (TR) 23.700-80 FS_AIMLsys study has not addressed the range of engagement models that AFs and UEs can follow to participate in FL, e.g. most solutions focus on the Application Function (AF) communicating with the 5G Core (5GC) using a Network Exposure Function (NEF) to set up connections with particular QoS treatment so that FL models with HFL aggregation mode can be deployed. Flexibility in aggregation is advocated above, and it can be achieved through other engagement models which do not conform to 3GPP solutions. To the best of the authors knowledge, there have been no attempts to address such engagement models. This disclosure proposes a method by which the applications servers can initiate connections for FL in a way that it allow for standalone model FL or for collaborative FL, and that only authorized AF may follow. The details of this engagement model and solutions are outlined below.

As part of the present disclosure, a novel 5GC functionality, co-located with a new or existing (logical) NF, is provided to support flexible aggregation mode selection in any federated learning workflow, which is called Federated Learning Aggregator Manager (FLAM). The FLAM can also be deployed at RAN side (e.g. in Central Unit (CU) at the gNB). In concrete, FLAM may be deployed in any network entity and/or function that is in charge of performing federated learning.

This solution assumes that one or more applications servers (or network entities such as Model Training Logical Function (MTLF) (within or separate from Network Data Analytics Function (NWDAF)) or RAN ML models), wishing to collaborate in the training of particular ML model. To do so a set of participants (e.g. UEs, MTLFs, network entities/functions, etc.) are selected for FL operations. The selection of the participants for FL is assumed to be the responsibility of the application layer and/or the network training instance (in case a ML for network application is to be trained using a FL workflow). The FLAM may have the required functionality to inform, recommend and/or select an FL aggregation mode and configure its operation to a set of participants (e.g. UEs, MTLFs, network entities/functions, etc.).

The FL aggregation mode determines the level of coordination required for sharing and/or aggregation of participants' models that reach a central server of the FLAM system. Aggregation of shared models in HFL or top-level models in VFL, will happen on the application(s) side(s).

The determination of the FL aggregation mode should be done in accordance with 5GS state. Similarly the participant selection and the determination of FL aggregation mode may be an application layer decision. 5GS should provide relevant information (including analytics) and/or a recommendation about the FL aggregation mode.

The distinct FL aggregation modes that this disclosure considers are:
I. Horizontal Federated Learning (HFL): when the FL workload participants share the same set of features and labels from distinct sample spaces.
II. Vertical Federated Learning (VFL): when the FL workload participants share the same sample space but their data is composed of distinct features and labels.
III. Hybrid Federated Learning (HyFL): when there is a subset of participants that have the same common features and labels from distinct sample spaces and at the same time there is a subset of participants with different features and labels from the same sample space.

The FLAM entity may also identify the distinct KPIs needed to perform the selected aggregation method. For example, PSI when VFL is selected or accuracy when HFL is chosen. The FLAM will suggest a list of monitoring KPIs for the application server to track in order to identify model training performance.

Functional to the definition of the procedures, we consider that there are N participants

$${\{ {ℱ}_{i} \}}_{i = 1}^{N}$$

interested in offering their data and resources for training a cooperative ML model. Each party has their respective datasets [symbol] . On the other hand, there are

$$M \geq 1 AFs {\{ {𝒬}_{j} \}}_{j = 1}^{M}$$

willing to use the data [symbol] of the participant [symbol] to train a target model [symbol] without directly accessing their data.

### Creation/Execution of an FL Workload

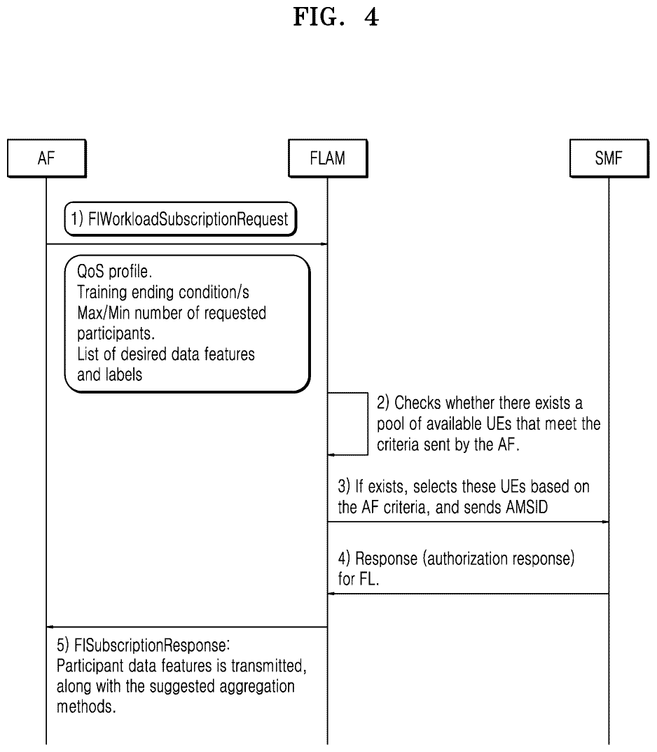

FIG. 4 shows an example flow chart of possible setups in this disclosure in relation to the creation/execution of an FL workload. The Figure shows message exchange between AF, FLAM and/or SMF in relation to the FL workload subscription request and response procedure.

FIG. 4 schematically depicts FlSubscriptionRequest/FlSubscriptionResonse message exchange.

As soon as a new AF needs to run/re-run an FL workload, it sends a request message to the FLAM with information related to the FL workload. For example, in FIG. 4, the AF sends to the FLAM the FlWorkloadSubscriptionRequest message that may contain, for example, the following information:
Requested Quality-of-Service (QoS) profile—The level of QoS associated with the end-to-end communications between the participants involved in the FL workload and the AFs instance backing the FL workload;
Training ending condition/s—Specific to the FL workload which includes, but is not limited to, maximum number of model updates, maximum training time, validation loss crossing threshold, etc.;
Minimum/maximum number of requested participants—Minimum/maximum number of participants that are expected to take part in the FL workload;
Minimum/Maximum amount of resources (e.g., memory and CPU footprint) to be reserved by each participant involved in the FL workload;
List of desired data features and labels—The list of features that the AF wants the input data to have and upon which the model is to be based, and its associated labels.
Any other assistance information related to FL workload creation and/or handling.

Upon sending the FlWorkloadSubscriptionRequest, the AF starts a count-down timer, e.g., FL response timer. After receiving the FlWorkloadSubscriptionRequest, the FLAM selects, from its pool of available UEs for the FL workload, a list of possible candidates. The FLAM analyses each UE based on the AF criteria. If there exists (available) a pool of UEs to start the FL workload, the FLAM requests its inclusion to the FL workflow to SMF sending the AMSID, and sends the list of available UEs to the AF. Based on the existing (availability) of UEs that meet the AF criteria, the FLAM may respond, for example, with the following message:
FlSubscriptionResponse—FLAM has received enough subscription requests from parties (e.g. UEs, other network entities and/or functions) with the desired specs willing to take part in the FL workload(s). As such, enough resources can be found in the pool of UEs to accommodate the new FL workload. The FLAM sends to the AF a list of data features found on the participants alongside with the suggested aggregation method.

If the FLAM does not have access to enough parties and/or resources across the pool of UEs to accommodate the new FL workload, or the data features do not match the requested by the AF, the AF timer will expire and the AF can start a FL with another FLAM entity.

The aforementioned exchange of messages is shown in FIG. 4.

Note that the above shows an example of the proposed solution/method for creation/execution of an FL workload, and that other steps/states/messages/signalling could also be included in the above description/figure, however, were removed above for simplicity of description.

### UE Subscription to a FLAM Workload Execution and Monitoring

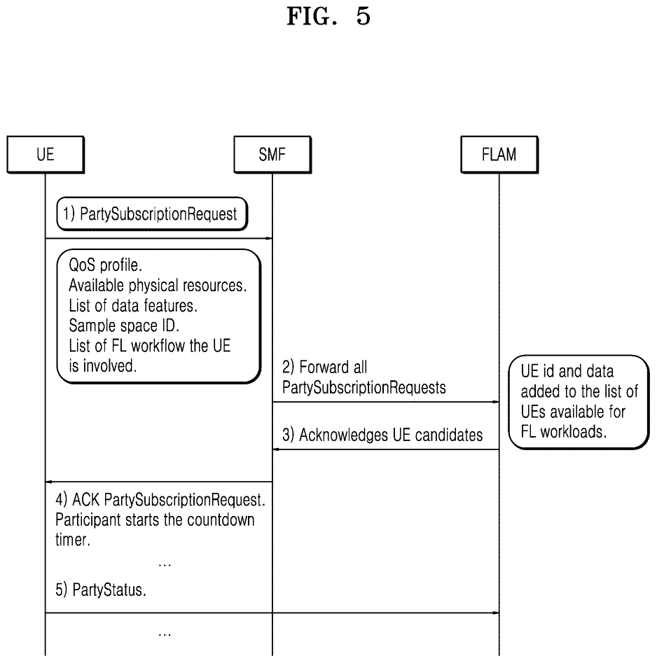

FIG. 5 schematically depicts PartySubscriptionRequest and UeStatus exchange of messages.

Each party (e.g. UE, MTLF instance, etc.) willing to participate in FL workloads may submit a subscription request (e.g. PartySubscriptionRequest message) to the SMF. As a part of the subscription request, the party shall declare:
The available amount of hardware resources (e.g. CPU, RAM, storage, GPU unit, etc)
The set of data features and labels available within is dataset, and the sample space ID.
The number of active FL workloads that the UE is currently involved.

As soon as the SMF receives a PartySubscriptionRequest message, it forwards the information to the FLAM and the party is added to the pool of UEs willing to take part in FL workloads that is tracked by the FLAM. PartySubscriptionRequest messages are always followed by timer countdown. The timer starts when an acknowledge message from the SMF is received by the UE, that confirms the UE inclusion to the available participants for FL workloads. If the countdown timer expires without receiving the any further instruction, the UE may become available to other workloads.

Periodically, each party that successfully subscribed to the FLAM (via a PartySubscriptionRequest message) communicates its status (for example, via the PartyStatus message) to the FLAM containing the following fields:
Number of active FL workloads the UE is taking part in;
Available computational, memory and storage resources;
PDU error rate—averaged over a given time interval and calculated in uplink at the Packet Data Convergence Protocol (PDCP) level.
Available Features list, labels and sample space ID.

PartyStatus messages allow the FLAM to reconfigure, on the fly, the training mechanism. Therefore, allowing for distinct aggregation solution to be changed over time. The aforementioned exchange of messages is shown in FIG. 5.

Note that the above shows an example of the proposed solution/method for creation/execution of an FL workload, and that other steps/states/messages/signalling could also be included in the above description/figure, however, were removed above for simplicity of description.

### HFL Procedure

In HFL, participants with identical features and labels obtained from distinct sample space IDs, that fulfill the conditions specified by the aggregation entity, e.g., the AF, on the FlWorkloadSubscriptionRequest are selected by the FLAM. In this procedure, a model from the AF is sent to the participants (e.g. UEs, network entities and/or functions, other), and these participants train the model using the available local data samples. The training methodology, i.e., batch size, optimizer model, learning step, gradient resolution, etc. is selected by the AF or the model aggregation entity at the beginning of the FL workload process. The frequency of the global model update, whether any participant should stop computing gradients once it has sent the local updates, if gradient computation should resume when participants receive a updated global model, etc. The decision is also made on the application side. The main idea behind this solution is that all participants in the FL workload share the same model architecture and training procedure, and that local updates computed by the participants are then sent to the model aggregation entity.

The HFL aggregation mode, within or separate from NWDAF, is currently covered in the 3GPP TR (23.700-81 cl. 8.8). This disclosure also encompasses, but is not limited to, RAN models that might be trained using FL. For example, the training entities taking part in the FL can be gNBs (or NG-RAN, eNB), distinct MTLFs instances (e.g. RAN model aggregation at the core) of the 5GC, different OAMs, different Central Units of the RAN, a group of UEs and/or virtual entities consisting of the gNB (or NG-RAN, eNB), and UE, when training a model as defined by 3GPP RAN study group. For example, in the case of joint training of two-sided model, with collaboration on model training between the UE and the network. In another example, the training is performed jointly between one part of the model (or the model) at the UE and the other model part (or the model) at the network side.

The following is an example that describes the potential interaction between the AF, FLAM, and participants in the HFL model aggregation procedure:
Step 0 (Pre-Condition): An AF start/triggers the i-th FL workload process.
Step 1: The AF sends the FlSubscriptionRequest message to FLAM (which is the entity running/handling the FL workload procedure).
Step 2: The FLAM selects the participants set [symbol] as the participants expected to take part in the considered FL workload.
Step 3: The FLAM shares the suggested model aggregation(s) configuration(s) with the AF.
Step 4: The AF implements a specific aggregation mode and shares the initial model [symbol] with the participants of [symbol] as well as the training hyper parameters (e.g. learning rate, step size, etc.);
Step 5: Each participant i trains the model using their local data [symbol] . Then:
a) They send the updated local model to the AF for aggregation.
b) If a new global model is received before they have obtained the final results, the participants either start over with the new model or continue with the training based on the instructions received at the workload initiation.
Step 6: The AF aggregates the received model(s) using any horizontal model aggregation, e.g., FedAvg, and:
a) Broadcasts the new model (e.g. synchronous FL)
b) Sends the obtained model to a user or group of users (e.g. asynchronous FL).
Step 7: The FLAM receives the new model and computes the ending criteria, (e.g. number of rounds, accuracy test, etc.). If any condition of the terminating criteria is met, then the FLAM stops the FL workload.

### VFL Procedure

In VFL, participants with different features and labels that were obtained from the same sample space IDs, and satisfy the conditions specified by the AFs included in the FlWorkloadSubscriptionRequest message, are selected by the FLAM. VFL is the process of aggregating these different features and computing the training loss and gradients in a privacy-preserving manner to build a model with data from all parties collaboratively. The training methodology, i.e., batch size of the training sample, optimizer model, learning step, gradient resolution, etc. is selected by the AF or network entity in charge of the model aggregation at the beginning of the workload.

For example, the learning methodology is described in the following:

### Running Process:

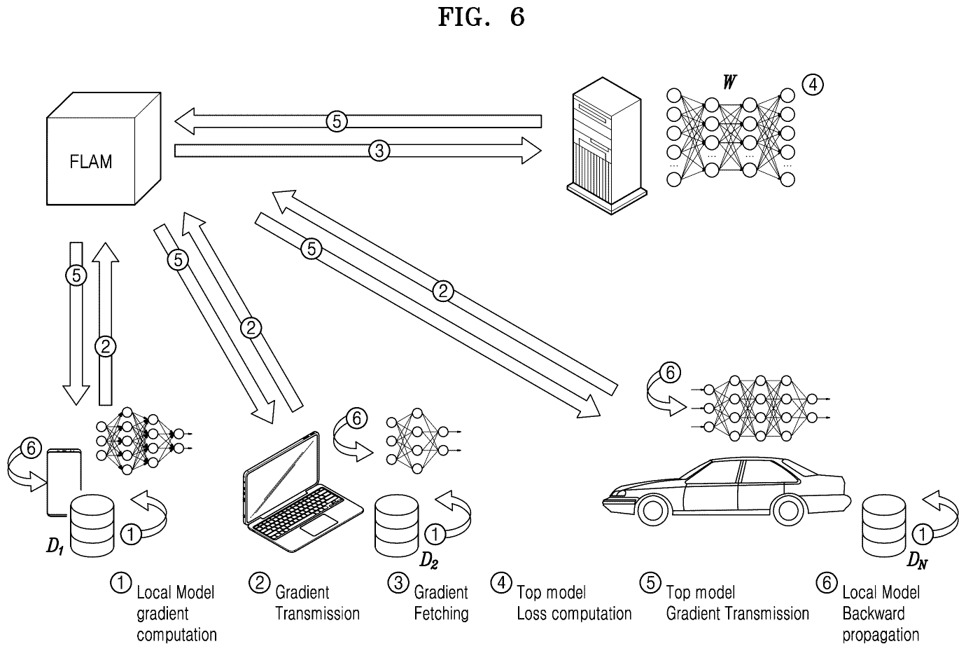

step 0 (Pre-Condition): Before model training, the FLAM needs to find the common identifiers (IDs) served by all participants to align the training data samples. There are different methodologies for aligning data samples, cosine similarity, private set intersection (PSI), Shapley values. For example, PSI could be leveraged which is a secure multiparty protocol which allows multiple participants to find the common IDs available across their data. PSI techniques can include naive hashing, oblivious polynomial evaluation, and oblivious transfer, among others. For this setting there is distinct ML models, the model of the aggregating entity, which is herein referred to as the top model, and the model at each participant, referred to as a local model. This aggregation mechanism considers that one or several AFs and/or aggregation entities want to train a model using VFL. FIG. 6 shows an example of a VFL procedure.

FIG. 6 schematically depicts an example of a VFL procedure.
Step 1: After determining the aligned data samples among all participants, each participant will complete a forward propagation process using, for example, its local data and/or model. This forward propagation process consists of propagating the data through the local model and calculating the loss value. It is worth noting that each participant might have a different local model with a different architecture but has a common loss function.
Step 2: Following, each participant needs to transmit its outputs to the FLAM. For example, the transmitted output may contain intermediate results of local neural networks, which transform the original attributes into features. These features will be used as inputs to the top models, and are used to compute the top model gradients. To do so, each participant sends to FLAM the obtained gradients.
Step 3: The aggregation entity fetches the gradient values from the FLAM, and it uses the collected outputs from all participants as input data of the top model. Based on the obtained data, the aggregation entity computes the loss value based on the retrieved initial data labels. The process is known as top model forward propagation.
Step 4: Following, the top model performs backward propagation and computes the gradients for the model parameters of the top model. The aggregation entity then forwards the initial layer gradients to the FLAM.
Step 5: The FLAM forwards to each participant, its corresponding gradients according to the features that each participant contributed. Using the gradients of the top model, each participant can calculate the average gradients for each batch of samples used locally, and then update its local model.
Step 6: The bottom model backward propagation. Each participant calculates the gradients of its local model parameters, based on the local data and the gradients of the forward outputs from the aggregation entity, and then updates its local model.

For this procedure distinct types of participants fall under this scope, depending on where the training would take place. For example, if the training takes place at:
The core network (e.g., 5GC or 6GC) side: VFL can be leveraged between distinct MTLF instances within NWDAF or separate from NWDAF. This requires different MTLFs to register for FL workloads in the FLAM, by sending their respective PartySubscriptionRequest with the corresponding data features and labels to which they have access. Then, one MTLF, referred to as FL aggregation entity, will trigger the training process, by sending a FlWorkloadSubscriptionRequest message to the FLAM, selecting those MTLFs with data obtained from the sample space ID but with different features.
The RAN side: The VFL can be used within distinct training entities like gNBs (or NG-RAN, eNB), the Central Unit, the connected users, and a virtual entity consisting of a gNB (or NG-RAN, eNB) and a user (when the model and/or model related parameters are/is shared between these entities. For example, in the case of defined 3GPP RAN model training types (e.g. Type 1, 2, 3, and/or any other variation of these training types and/or new training collaboration types between the UE and the network). For example, in the case of joint training of two-sided model, training entities should first submit a PartySubscriptionRequest message, and following that, one of the entities triggers the FL training procedure in order to select the VFL aggregation method, e.g. via a FlWorkloadSubscriptionRequest message. In an example, the entity that triggers the FL training procedure (e.g. the UE or gNB) may act as the aggregation entity of the FL workflow procedure.

### The HyFL

The Hybrid Federated Learning (HyFL) procedure is a combination of the two aforementioned procedures. The HyFL aims to utilize all the available data in order to train a generic model. To do so, for example, it first launches a HFL training round, followed by a VFL training round. The combination of the HFL and VFL techniques will result in a more robust and generic solution. That is, the obtained model, using the HyFL training procedure, has been exposed to highly heterogeneous sets of data.

In HyFL, participants with the same or different features and labels that were collected from the same sample space IDs or from different space IDs, and also satisfy the conditions specified by the AFs in the FlWorkloadSubscriptionRequest message, are selected by the FLAM.

For example, the HyFL may first identify the common identifiers (IDs) of all participants in order to align the training data samples. Those with the same IDs, will be grouped and given the same ML model in order to perform HFL. The aggregation entity, will aggregate the gradients/models resulting from the HFL step on a per group basis. After that, the obtained model will be sent back to the group. Each participants of the group will perform a forward pass in their ML model, and the result of this forward pass will serve as novel features for the VFL step. Following, data samples will be aligned and the training loss and gradients will be computed to build a model with data from multiple parties at the same time, according to the steps of VFL, described in section 3.4.4. This process will be repeated until convergence.

The training methodology, i.e., batch size of the training sample, optimizer model, learning step, gradient resolution, etc., is selected by the AF and/or network entity in charge of the aggregation at the beginning of the FL workload for each process. That is, HFL and VFL. Notice that the training methodology can be different for distinct model aggregation solutions. For example, this procedure can be summarized as follows:

### Running Process:

Step 0 (pre-condition): Before model training, the FLAM needs to find the common identifiers (IDs) served by all participants to align the training data samples. Any metric defined for VFL can be leveraged for this step, e.g. PSI, Shapley values etc. Once the FLAM has identified the IDs, the participants with the same data features and labels obtained from distinct sample space IDs will be grouped together, and a group ID will be assigned to them.
Step 1: Following the alignment of the samples among all participants, each participant in the same group will share the same model. Following, it will complete a forward propagation step using, for example, its local data and/or model. This forward propagation process consists of propagating the data through the local model and calculating the loss value. Gradients and/or a resulting model will be shared with the FLAM.
Step 2: The FLAM will forward the obtained results to the aggregation entity that performs HFL model aggregation and sends back to the participants the resulting model.
Step 3: The participants of each group will then complete a forward propagation process using its own data and/or model.
Step 4: Afterwards, each participant needs to transmit their outputs to the FLAM. The transmitted output contains intermediate results of local models, which transform the original attributes into features. Using these features as input, the top model will calculate its gradients.
Step 5: The aggregation entity fetches the gradient values from the FLAM, and it uses the collected outputs from all participants as input data for the top model. Equivalent to the step defined as forward propagation from a top model.
Step 6: For example, in the following step, the top model calculates gradients for its model parameters by performing backward propagation. Next, the FLAM receives the gradients of the initial layer from the aggregation entity.
Step 7: Based on the features that each participant contributed, the FLAM forwards its corresponding gradients to each participant. By using the gradients of the top model, each participant can calculate the average gradients for each batch of samples used locally, and then updates its local model accordingly.
Step 8: Based on the local data and the gradients obtained from the aggregation entity, each participant calculates the gradients of its local model parameters.
Step 9: And the HFL starts again. The process is repeated until convergence.

Based on where the training would take place, distinct types of participants would fall under this scope. In case it takes place at:
The core network (e.g., 5GC or 6GC) side: VFL can be leveraged between distinct MTLF instances within NWDAF or separate from NWDAF. By sending their respective PartySubscriptionRequests message with the data features and/or labels to which they have access, different MTLFs will be able to register for FL workloads in the FLAM. The MTLFs that fulfill the conditions specified in FlWorkloadSubscriptionRequest message that is sent to the FLAM will be selected. The entity responsible for the FlWorkloadSubscriptionRequest will be chosen as the FL aggregation entity.
The RAN side: The VFL can be used within distinct training entities like gNBs (or NG-RANs, eNBs), the Central Unit, the connected users, and a virtual entity consisting of a gNB and a user (when the model is shared between these two entities, as it is the case, for example, in training models (e.g. training type 1, 2, or 3 defined in 3GPP RAN study items). These entities should first submit a PartySubscriptionRequest, and then one of them has to trigger the FL training procedure by selecting the VFL aggregation method via a FlWorkloadSubscriptionRequest. The entity that triggers the FL training procedure will act as the aggregation entity of the FL workflow.

### Use Case

### RAN Slicing

Considering a network with end-to-end network slices (NS) that span both core network (CN) and radio access network (RAN). In order to improve the efficiency and resource utilization of the virtualized networks, there are a set of ML solutions available from different vendors to orchestrate the virtualized resources of each NS.

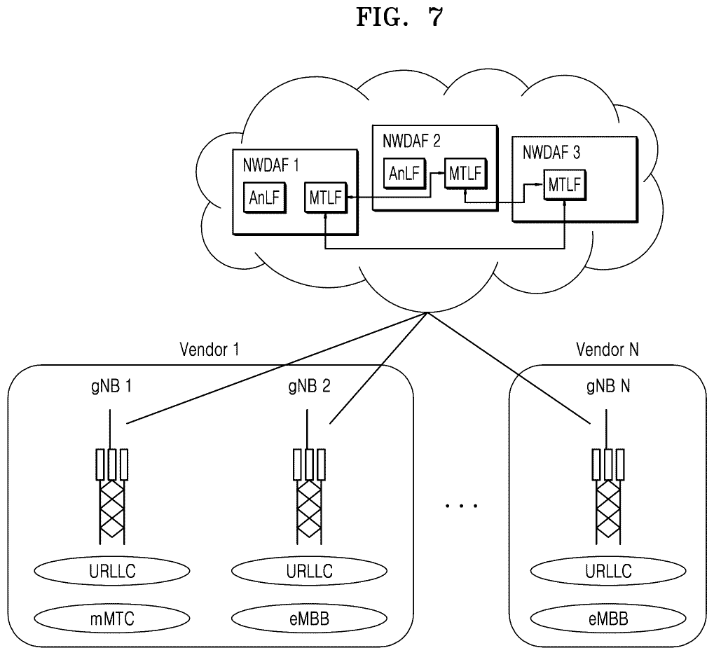

FIG. 7 schematically depicts a RAN slicing use case.

A gNB (or NG-RAN) component comprises not only the NR functionalities, but also procedures for Radio Resource Management (RRM). Each RRM procedure at the same time may be controlled by a vendor-specific ML algorithm that guarantees the performance requirements of each NS and its connected UEs, while the available radio resources are efficiently used. To implement RAN slicing in each RRM procedure, it is reasonable to implement a two-level algorithm: inter-slice and intra-slice.
At inter-slice level, a RRM algorithm handles the management of all the RAN slice subnets considering the available radio resources on the whole RAN infrastructure.
At intra-slice level, this algorithm is specific for a RAN slice subnet and it is designed to meet its requirements and it only considers the allocated radio resources for this RAN slice subnet.

It is clear that each ML algorithm has access to distinct type of data that can be used to improve the performance of current solutions and/or to develop more general ones, using the data available from distinct NSs. To do so, for example, imagine that the vendor-specific ML solutions for RRM orchestration are located in the 5GC, and the network operator decides to train a more general/generic model using these instances. To do so the following FL solutions are available:
HFL training for RRM orchestration: The distinct AI/ML solutions for the same type of NS that are spanned in different geographical locations can be used to train a model. In this setting the AI/ML models have access to the same data features (e.g. UEs data/measurements information, RSRPs, location information, PRB utilization, RRC states, other information, etc.), and this type of data is obtained from distinct sample spaces, e.g. different geographical locations. FIG. 7 captures an example of a possible HFL training procedure with RAN models being trained at the 5GC where the participants of the FL workflow are distinct MTLF instances. As we can see distinct vendor equipment spans different types of NSs, and the data from these NSs can be leveraged to start a FL in the 5GC, where the RRM ML orchestration solutions lie. One of the MTLF solutions will be chosen as the aggregation entity and thus, in charge of compiling and adding the gradients/models obtained for the other MTLF instances.
VFL training for RRM orchestration: Different AI/ML solutions for different types of NS can co-exist in the same geographical area. A network operator could leverage the distinct sample data features (e.g. URLLC, eMMB specific type of data), obtained from the same environment, e.g. same geographical area with traffic highly correlated, to train a more robust model in a VFL manner.
HyFL training for RRM orchestration: This setting will be a combination of the two aforementioned settings (i.e. HFL and VFL). The network operator might want to train a model in a federated learning way, exploiting all the data available across the network. For example, this could be achieved by first triggering the HyFL step between NSs of the same type, that are located in different geographical areas. Then combine the VFL training step based on the results obtained using the data of distinct NSs, that span the same geographical area.

All proposals, embodiments, solutions, procedures, and examples in this disclosure may also apply for the gNB, NG-RAN case and all related RRC signaling and/or messages, and X2, Xn, S1, NG, F1, E1 signaling and messages, and/or related network entities (e.g. MME, AMF, UPF, other).

All proposals, embodiments, solutions, procedures, and examples in this disclosure describing FL model aggregation, and interaction between FL workload participants, network entities and/or functions, and/or the novel entity (co-located with a new or existing (logical) NF), named FLAM, can use existing and/or RRC and/or NAS signalling/messages (and/or IEs). Additionally, FL workload messages maybe exchanged using system information broadcast (e.g. periodic and/or on-demand) and/or using dedicated RRC/NAS signalling/messages.

### Advantages & Novel Features of the Disclosure

The present disclosure provides a novel methodology for Hybrid Federated Learning (HyFL) model aggregation, where the FL models can be aggregated in multiple modes, i.e., horizontal, vertical or hybrid.
The present disclosure provides the use of novel entity, co-located with a new or existing (logical) NF, named FLAM, which is in charge of assisting on the creation/run to completion/destruction of an FL workload, recognizing/suggesting the best aggregation mechanism, and selecting the participants (e.g., UEs, network entities and/or functions, MEC servers, etc.) for any FL workload. The present disclosure also makes provisions for the participants taking part in the FL workload to be re-organized during the execution of the FL workload.
The present disclosure also specifies a new set of monitoring metrics that will be leveraged to perform the VFL and HyFL aggregation mechanism. Such set includes the definition of Private Set Intersection, Shapley values, Cosine similarity, among other metrics.

### Annex (3GPP RAN Study Item on AI/ML Air Interface)

### 3GPP RAN Study Item on AI/ML (RP-213599, Study on Artificial Intelligence (AI)/Machine Learning (ML) for NR Air Interface)

### 4.1 Objective of SI or Core Part WI or Testing Part WI

Study the 3GPP framework for AI/ML for air-interface corresponding to each target use case regarding aspects such as performance, complexity, and potential specification impact.

Use cases to focus on:
Initial set of use cases includes:
   CSI feedback enhancement, e.g., overhead reduction, improved accuracy, prediction [RAN1]
   Beam management, e.g., beam prediction in time, and/or spatial domain for overhead and latency reduction, beam selection accuracy improvement [RAN1]
   Positioning accuracy enhancements for different scenarios including, e.g., those with heavy NLOS conditions [RAN1]
Finalize representative sub use cases for each use case for characterization and baseline performance evaluations by RAN #98
   The AI/ML approaches for the selected sub use cases need to be diverse enough to support various requirements on the gNB-UE collaboration levels

Note: the selection of use cases for this study solely targets the formulation of a framework to apply AI/ML to the air-interface for these and other use cases. The selection itself does not intend to provide any indication of the prospects of any future normative project.

AI/ML model, terminology and description to identify common and specific characteristics for framework investigations:
Characterize the defining stages of AI/ML related algorithms and associated complexity:
   Model generation, e.g., model training (including input/output, pre-/post-process, online/offline as applicable), model validation, model testing, as applicable
   Inference operation, e.g., input/output, pre-/post-process, as applicable
Identify various levels of collaboration between UE and gNB pertinent to the selected use cases, e.g.,
   No collaboration: implementation-based only AI/ML algorithms without information exchange [for comparison purposes]
   Various levels of UE/gNB collaboration targeting at separate or joint ML operation.
Characterize lifecycle management of AI/ML model: e.g., model training, model deployment, model inference, model monitoring, model updating
Dataset(s) for training, validation, testing, and inference
Identify common notation and terminology for AI/ML related functions, procedures and interfaces
Note: Consider the work done for FS_NR_ENDC_data_collect when appropriate

For the use cases under consideration:
1) Evaluate performance benefits of AI/ML based algorithms for the agreed use cases in the final representative set:
   Methodology based on statistical models (from TR 38.901 and TR 38.857 [positioning]), for link and system level simulations.
      Extensions of 3GPP evaluation methodology for better suitability to AI/ML based techniques should be considered as needed.
      Whether field data are optionally needed to further assess the performance and robustness in real-world environments should be discussed as part of the study.
      Need for common assumptions in dataset construction for training, validation and test for the selected use cases.
      Consider adequate model training strategy, collaboration levels and associated implications
      Consider agreed-upon base AI model(s) for calibration
      AI model description and training methodology used for evaluation should be reported for information and cross-checking purposes
   KPIs: Determine the common KPIs and corresponding requirements for the AI/ML operations. Determine the use-case specific KPIs and benchmarks of the selected use-cases.
      Performance, inference latency and computational complexity of AI/ML based algorithms should be compared to that of a state-of-the-art baseline
      Overhead, power consumption (including computational), memory storage, and hardware requirements (including for given processing delays) associated with enabling respective AI/ML scheme, as well as generalization capability should be considered.

### 3GPP RAN1 #110 Meeting, Chairman Report

### Agreement

In CSI compression using two-sided model use case, the following AI/ML model training collaborations will be further studied:
Type 1: Joint training of the two-sided model at a single side/entity, e.g., UE-sided or Network-sided.
Type 2: Joint training of the two-sided model at network side and UE side, respectively.
Type 3: Separate training at network side and UE side, where the UE-side CSI generation part and the network-side CSI reconstruction part are trained by UE side and network side, respectively.
Note: Joint training means the generation model and reconstruction model should be trained in the same loop for forward propagation and backward propagation. Joint training could be done both at single node or across multiple nodes (e.g., through gradient exchange between nodes).
Note: Separate training includes sequential training starting with UE side training, or sequential training starting with NW side training [, or parallel training] at UE and NW
Other collaboration types are not excluded.

### Apparatus for the Proposals of the Present Disclosure

A UE which is arranged to operate in accordance with any of the examples of the present disclosure described above includes a transmitter arranged to transmit signals to one or more RANs, including but not limited to a satellite network and a 3GPP RAN such as 5G NR network; a receiver arranged to receive signals from one or more RANs and other UEs; and a controller arranged to control the transmitter and receiver and to perform processing in accordance with the above described methods. The transmitter, receiver, and controller may be separate elements, but any single element or plurality of elements which provide equivalent functionality may be used to implement the examples of the present disclosure described above.

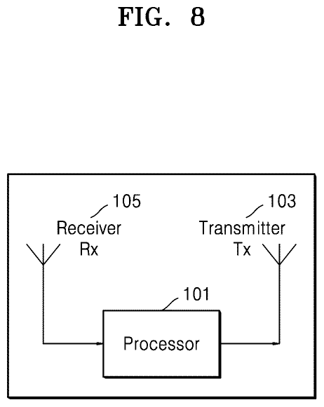

FIG. 8 is a block diagram of an exemplary network entity that may be used in the implementation of the examples of the present disclosure. For example, the user equipment (UE), entities of the network-side, core network (CN) or radio access network (RAN) (e.g. eNB, gNB or satellite) may be provided in the form of the network entity illustrated in FIG. 8. The skilled person will appreciate that a network entity may be implemented, for example, as a network element on a dedicated hardware, as a software instance running on a dedicated hardware, and/or as a virtualized function instantiated on an appropriate platform, e.g. on a cloud infrastructure.

The network entity comprises at least one processor (or controller) 101, at least one transmitter 103 and at least one receiver 105. The receiver 105 is configured for receiving one or more messages from one or more other network entities, for example as described above. The transmitter 103 is configured for transmitting one or more messages to one or more other network entities, for example as described above. The processor 101 is configured for performing one or more operations, for example according to the operations as described above. The transmitter 103 and the receiver 103 may be referred to as a transceiver.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

A particular network entity may be implemented as a network element on a dedicated hardware, as a software instance running on a dedicated hardware, and/or as a virtualized function instantiated on an appropriate platform, e.g. on a cloud infrastructure.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the present disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. Examples of the present disclosure extend to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

The above embodiments are to be understood as illustrative examples of the present disclosure. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be used without departing from the scope of the disclosure, which is defined in any accompanying claims.

1. A method of federated learning (FL) model aggregation in a communication system, the method comprising:
combining one or more models using horizontal FL (HFL) and/or one or more models using vertical FL (VFL).

2. A network entity including a federated learning aggregator manager (FLAM) configured to implement the method according to claim 1.

3. The network entity according to claim 2, wherein:
the FLAM is a part of or co-located with an existing or newly defined network entity; and/or
one or more steps performed by the FLAM are performed by a set of one or more network entities including an existing network entity and/or a newly defined network entity.

4. A method of creating a federated learning (FL) workload by an application function (AF) in a communication system, the method comprising:
sending, to a federated learning aggregator manager (FLAM), a message comprising information related to the FL workload, wherein the message causes the FLAM to select a list of possible candidates from a pool of available parties including UEs for the FL workload and to request, to a session management function (SMF), inclusion of the pool of available parties to the FL workflow;
starting a timer; and
receiving, from the FLAM, the list of possible candidates.

5. The method according to claim 4, wherein the information comprises one or more of:
requested Quality-of-Service profile;
at least one training ending condition;
maximum/minimum number of requested participants;
minimum/maximum amount of resources;
a list of desired data features and labels; or
assistance information related to FL workload creation and/or handling.

6. The method according to claim 4, further comprising:
in case that the FLAM does not have access to enough parties and/or resources across the pool of available parties to accommodate the FL workload, or data features do not match features requested by the AF, expiring the timer and starting a FL with another FLAM entity.

7. A method of subscribing to a federated learning (FL) workload by a party including at least one of a user equipment (UE) or a model training logical function (MTLF), the method comprising:
submitting a subscription request to a session management function (SMF);
forwarding, to a federated learning aggregator manager (FLAM), the subscription request, wherein the subscription request causes the FLAM to add the party to a pool of available parties for the FL workload; and
starting a timer.

8. The method according to claim 7, wherein the subscription request comprises one or more of:
available amount of hardware resources;
a set of data features and labels available within its dataset, and a sample space ID; or
a number of active FL workloads that the party is currently involved.

9. The method according to claim 7, wherein starting the timer is in response to receiving an acknowledge message from the SMF, wherein the acknowledge message confirms that the party is included to the pool of available parties for FL workloads.

10. The method according to claim 7, wherein in case that the timer expires without receiving any further instruction, the party becomes available to other workloads.

11. The method according to claim 7, further comprising:
communicating periodically status to the FLAM,
wherein the status comprises one or more of:
a number of active FL workloads the party is taking part in;
available computational, memory and storage resources;
protocol data unit (PDU) error rate; or
available Features list, labels and sample space ID.

12. The method according to claim 7, wherein a training mechanism is reconfigured by the FLAM.

13. A method of training a machine learning (ML) model of a federated learning (FL) workload by an application function (AF) in a communication system, the method comprising:
sending, to a federated learning aggregator manager (FLAM), a request for the FL workload, wherein the request causes the FLAM to select a pool of available parties for the FL workload;
receiving, from the FLAM, at least one suggested model aggregation configuration;
implementing a specific model aggregation configuration of the at least one suggested model aggregation configuration;
sharing, with at least one party of the pool of available parties, a model based on the specific model aggregation configuration;
receiving, from the at least one party of the pool of available parties, at least one model trained using local datasets;
aggregating the received at least one model using horizontal model aggregation; and
transmitting the aggregated model.

14. A method of training a machine learning (ML) model of a federated learning (FL) workload by a federated learning aggregator manager (FLAM) in a communication system, the method comprising:
identifying one or more common identifiers served by a pool of available parties;
aligning data of local datasets of the pool of available parties;
receiving, from at least one party of the pool of available parties, an output of a forward propagation process executed using a local dataset and/or a local model;
computing a top model using the received output of the forward propagation process; and
forwarding, to the at least one party of the pool of available parties, information from the top model, wherein the information from the top model causes the at least one party to update the local model.

15. The method according to claim 14, wherein parties having one or more common identifiers are grouped into at least one group, and wherein the forward propagation process is executed using a same model for each group.
